(19) United States
(12) Patent Application Publication
(10) Pub. No.: US 2008/0089210 A1
(43) Pub. Date: Apr. 17, 2008

(54) Solid immersion lens, and condenser lens, optical pickup device, and optical recording/reproducing apparatus including the solid immersion lens

(75) Inventors: Kimihiro Saito, Saitama (JP); Ariyoshi Nakaoki, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/785,952

(22) Filed: Apr. 23, 2007

(30) Foreign Application Priority Data
Apr. 24, 2006 (JP) 2006-119348

(51) Int. Cl. G11B 7/135; G02B 1/11

(52) U.S. Cl. 369/112.24; 359/642; 359/796

(57) ABSTRACT

A solid immersion lens includes a spherical part being hemispherical on the side opposite to an object and an anti-reflection coating provided at least in an incidence range of incident light on the hemispherical spherical part.

### CROSS REFERENCES TO RELATED APPLICATIONS

The present invention contains subject matter related to Japanese Patent Application JP 2006-119348 filed in the Japanese Patent Office on Apr. 24, 2006, the entire contents of which are incorporated herein by reference.

### BACKGROUND OF THE INVENTION

1. Field of the Invention

The present invention relates to a solid immersion lens, as well as a condenser lens, an optical pickup device, and an optical recording/reproducing apparatus, which include the solid immersion lens.

2. Description of the Related Art

Optical or magnet optical recording media represented by a CD (compact disc) and a DVD (digital versatile disc) have been widely used for storing music information, image information, data, and a program therein. In a system recording information on or reproducing it from these optical recording media, an objective lens opposes the surface of the optical recording medium with a clearance therebetween so as to read microscopic recorded marks by detecting the unevenness formed on the recording surface of the optical recording medium or changes in reflection factor of a phase change material. In the case of the magnet optical recording system, the objective lens opposes the optical recording medium to read marks by detecting a magnetic domain structure in that the relation force/rotational angle is changed.

In such an optical recording medium, since approaches for increasing capacity and recording density have been demanded recently, techniques have been discussed for forming recorded marks on the optical recoding medium to be less microscopic so as to read them with high resolution.

The spot size of light irradiated on the optical recording medium is approximately given by λ/NA_{obj}, where λ is the wavelength of the irradiated light and NA_{obj} is the numerical aperture of the condenser lens for condensing the light on the optical recording medium, and the resolution is also proportional to this value. The numerical aperture NA_{obj} is given as below:
NA_{obj}=n_{A}×sin θ,
where n_{A} is the refraction index of the medium intervening between the lens and the optical recording medium, that is air; and θ is the incidence angle of a light beam in the vicinity of the objective lens. Since the medium is air, NA_{obj} cannot exceed 1, so that the resolution has a limit. Hence, in the optical recording/reproducing apparatus, the wavelength of its source light, such as semiconductor laser, is reduced and the numerical aperture of the condenser lens is increased.

Whereas, as a technique for achieving a numerical aperture of 1 or more, a recording/reproducing system with so-called near-field light (a near-field optical recording/reproducing system) has been proposed using evanescent waves, i.e., the light exponentially attenuating from a boundary surface. In the near-field optical recording/reproducing system, it is necessary to extremely reduce the clearance between the condenser lens and the optical recording medium surface.

As a technique that recording/reproducing by irradiating near-field light on the optical recording medium, a method for near-field light recording/reproducing has been proposed in that an objective optical lens and a solid immersion lens are combined together so as to form a near-field optical system (see U.S. Pat. No. 5,125,750A).

As described in U.S. Pat. No. 5,125,750A, when an optical lens and the SIL (solid immersion lens) are combined together as a second group lens to be used as a condenser lens, the effective numerical aperture NA of the near-field optical system composed of the combined lenses is given as follows, when the SIL is hemispherical:
NA=n_{SIL}×sin θ (1),
when the SIL is super hemispherical:
NA=n_{SIL}²×sin θ 2),
where n_{SIL} is the refraction index of the material of the SIL, and θ is the incidence angle of a light beam incident on the SIL from the optical lens.

From the equations (1) and (2), it is understood that by increasing the refractive index of the material of the SIL, which is assumed to be a medium between the objective lens and the optical recording medium, the numerical aperture can be increased. In particular, when the SIL is super hemispherical, it is also understood that the effective numerical aperture NA can be rather increased if the refractive index is the same.

The material of the SIL is required to be cubic crystal that is isotropic in a crystal axial direction because of high light transmissivity and machinability. Such a material having a high refractive index includes S-LAH79™ made from OHARA INC. and high refractive index ceramics, as well as Bi₄Ge₃O₁₂, SrTiO₃, ZrO₂, HfO₂, and SiC, which are high refractive index monocrystal materials, in addition to high refractive index glass. In particular, for achieving a high numerical aperture, a super hemispherical SIL made of KTaO₃ is proposed (see M. Shinoda et al., “High-Density Near-Field Readout Using Solid Immersion Lens Made of KTaO₃ Monocrystal”, Japanese Journal of Applied Physics Col.45, No. 2B, 2006, PP.1332 to 1335).

### SUMMARY OF THE INVENTION

Although the super hemispherical SIL has an advantage in easily obtaining a high numerical aperture as mentioned above, it is difficult to improve dimensional accuracies, especially thickness accuracies with comparatively simple work during manufacturing, so that in the process of combining with the formed optical lens, the determination is necessary whether the thickness error is within the tolerable value. Hence, it may be difficult to be manufactured with high yield especially in mass production. Accordingly, it has been demanded to enable the more practical production using the hemispherical SIL by extending the tolerable range of the dimensional errors as well as to substantially achieve the same optical characteristics as those of the super hemispherical SIL.

In view of the problems described above, according to the present invention, it is desirable to maintain the optical characteristics in a SIL, of which manufacturing is easy, and to improve the productivity of a condenser lens, an optical pickup device, and an optical recording/reproducing apparatus, which include the SIL.

According to an embodiment of the present invention, there is provided a SIL (solid immersion lens) that includes a spherical part being hemispherical on the side opposite to an object and an anti-reflection coating provided at least in an incidence range of incident light on the hemispherical spherical part.

Preferably, the SIL is made of KTaO₃.

A condenser lens according to an embodiment of the present invention includes the SIL and an optical lens arranged opposite to the object and aligned with the SIL along an optical axis, in which the SIL includes the spherical part being hemispherical on the side opposite to the object and the anti-reflection coating provided at least in an incidence range of incident light on the hemispherical spherical part.

Furthermore, an optical pickup device and an optical recording/reproducing apparatus according to an embodiment of the present invention include the condenser lens including the SIL described above.

That is, according to the embodiment of the present invention, there is provided the optical pickup device that includes the SIL, the optical lens arranged opposite to the object and aligned with the solid immersion lens along the optical axis, and a light source, where light emitted from the light source is focused by the condenser lens composed of the SIL and the optical lens to form an optical spot, and where the SIL includes the spherical part being hemispherical on the side opposite to the object and the anti-reflection coating provided at least in an incidence range of incident light on the hemispherical spherical part.

According to the embodiment of the present invention, there is provided the optical recording/reproducing apparatus that includes the SIL, the optical lens arranged opposite to the object and aligned with the SIL along the optical axis, the light source, the optical pickup device configured to focus light emitted from the light source with the condenser lens composed of the SIL and the optical lens to form an optical spot, and a control driving unit configured to drive the condenser lens in a focusing direction and/or a tracking direction of an optical recording medium, where the solid immersion lens includes the spherical part being hemispherical on the side opposite to the object and the anti-reflection coating provided at least in an incidence range of incident light on the hemispherical spherical part.

As described above, since the SIL (solid immersion lens) according to the embodiment of the present invention includes the spherical part being hemispherical on the side opposite to the object, the tolerance of accuracies in shape, such as that of thickness errors, can be increased. Thus, the yield can be improved, in comparison with the producing the super spherical SIL, by simplifying the manufacturing process. Then, the SIL according to the embodiment of the present invention includes the anti-reflection coating provided at least in an incidence range of incident light on the hemispherical spherical part, so that the interference produced on the spherical SIL between incidence light and reflected light from the end face of the SIL can be suppressed, as will be described later, favorably maintaining optical characteristics. Furthermore, when the SIL according to the embodiment of the present invention is made of KTaO₃, a high numerical aperture can be easily achieved because of its high refraction index.

Accordingly, the use of such a SIL according to the embodiment of the present invention enables the mass production of SILs with favorable optical characteristics, so that the productivity of the condenser lens combined with the optical lens, the optical pickup device, and the optical recording/reproducing apparatus, which include the SIL, can be improved.

According to the embodiment of the present invention, there can be provided a SIL in that the fabrication is comparatively simple, and the deterioration in optical characteristics can be avoided or suppressed so as to favorably maintain the optical characteristics. The use of the SIL according to the embodiment of the present invention improves the productivity of the condenser lens with favorable optical characteristics as well as the optical pickup device and the optical recording/reproducing apparatus, which include the condenser lens.

### BRIEF DESCRIPTION OF THE DRAWINGS

FIG. 1 is a schematic sectional view of an example of a hemispherical solid immersion lens;

FIG. 2 is a schematic sectional view of an example of a super hemispherical solid immersion lens;

FIG. 3 is a graph showing the changes in wavefront aberration against the changes in thickness error of the solid immersion lens;

FIG. 4 is a schematic perspective view of an example of a condenser lens including the hemispherical solid immersion lens;

FIG. 5 is a picture of an example of the condenser lens including the hemispherical solid immersion lens;

FIG. 6 is a schematic perspective view of an example of a condenser lens including the super hemispherical solid immersion lens;

FIG. 7 is a picture of an example of the condenser lens including the super hemispherical solid immersion lens;

FIG. 8 is an observational picture of a comparative example of the hemispherical solid immersion lens;

FIG. 9 is an observational picture of a spherical part of a solid immersion lens according to an embodiment of the present invention;

FIG. 10 is an observational picture of a spherical part of the comparative example of the super hemispherical solid immersion lens;

FIG. 11 is a schematic sectional view of the solid immersion lens according the embodiment of the present invention;

FIG. 12 is a graph showing the change in transmission factor against the thickness of an anti-reflection coating;

FIG. 13 is a schematic view showing the configuration of an optical recording/reproducing apparatus having an optical pickup device according to a working example of the present invention;

FIG. 14 is a drawing showing waveforms reproduced by the optical recording/reproducing apparatus according to the working example of the present invention;

FIG. 15 is a drawing showing waveforms reproduced by an optical recording/reproducing apparatus of the comparative example; and

FIG. 16 is a graph showing the change in jitter by the optical recording/reproducing apparatus according to the working example of the present invention and the comparative example against the capacity of an optical recording medium.

### DESCRIPTION OF THE PREFERRED EMBODIMENTS

Preferred embodiments of the present invention will be described below; however, the invention is not limited to the embodiments below.

First, prior to the description of a working example, the discussed results about shapes of a hemispherical SIL and a super hemispherical SIL as well as tolerable ranges in thickness errors of these SILs will be described.

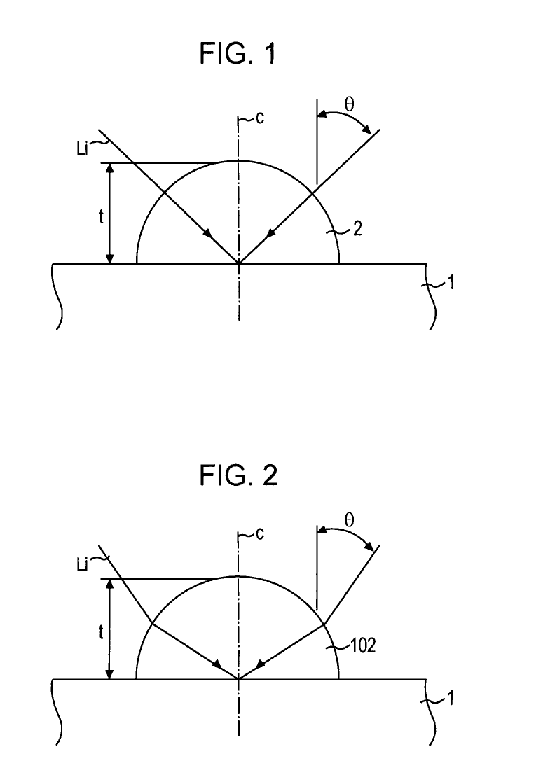

FIGS. 1 and 2 are schematic sectional views of a hemispherical SIL 2 and a super hemispherical SIL 102, respectively. Both FIGS. 1 and 2 show states in that the hemispherical SIL 2 and the super hemispherical SIL 102 oppose the surface of an optical recording medium 1 with a microscopic distance therebetween so as to irradiate incidence light L1, respectively. The thickness in an optical axial direction is denoted by “t”.

As described above, in the hemispherical SIL 2, the effective numerical aperture NA of the lenses combined with an optical lens is given as follows:
NA=n_{SIL}×sin θ (1),
in the super hemispherical SIL 102:
NA=n_{SIL}²×sin θ (2),
where n_{SIL} is the refraction index of the materials of the SILs, and θ is the incidence angle of the incidence light L1.

In configuration the condenser lens including the super hemispherical SIL, when the SIL is made of high refractive index glass, the refractive index n is about 2.0, so that the effective numerical aperture NA can have a value of about 1.84 when the SIL is combined with an optical lens with a numerical aperture of about 0.46. When the hemispherical SIL is made of the same material, even if it is combined with an optical lens with a high numerical aperture of about 0.8, which is used for Blue-ray Disc™, the effective numerical aperture NA can have a value of only about 1.6.

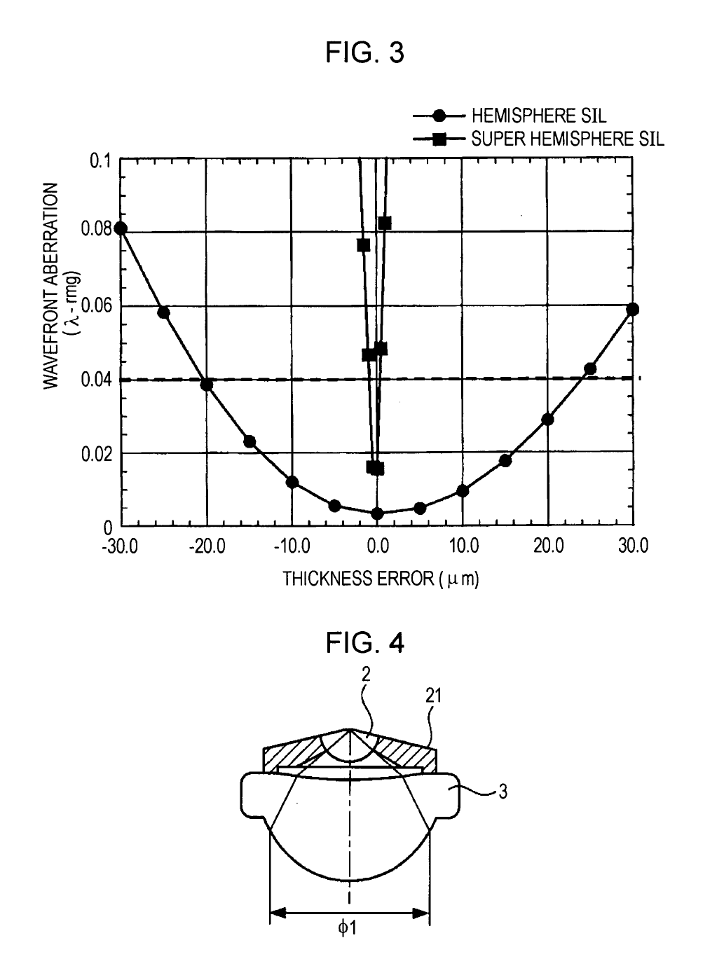

On the other hand, when the wavefront aberration is analyzed against the thickness error of the SILs along the optical axis, as shown in FIG. 3, it is understood that the tolerable errors of the super hemispherical SIL are extremely smaller than those of the hemispherical SIL.

For the range of the wavefront aberration (about 0.04 λrms) demanded for general optical recording media, the super hemispherical SIL has only an allowable error of ±2 μm or less while the hemispherical SIL has a width of margin of about +25 μm to −20 μm for the thickness with an error 0.0. Namely, for mass production of the SILs, the hemispherical SIL is more advantageous, which has remarkably larger tolerance in thickness error.

Then, as a cubic crystal material with a high refractive index and optical isotropy without double refraction, KTaO₃ (abbreviated as KTO below) is concerned and the hemispherical SIL made of the KTO has been discussed. The refractive index n of the KTO is about 2.38 for light with a wavelength of 405 nm. Hence, when the hemispherical SIL made of the KTO is combined with an optical lens with a numerical aperture of about 0.77, the effective numerical aperture of about 1.83 can be achieved for the light with a wavelength of 405 nm.

Actually, by producing the hemispherical SIL made of the KTO and the super hemispherical SIL made of the high refractive index glass, their characteristics were compared and discussed.

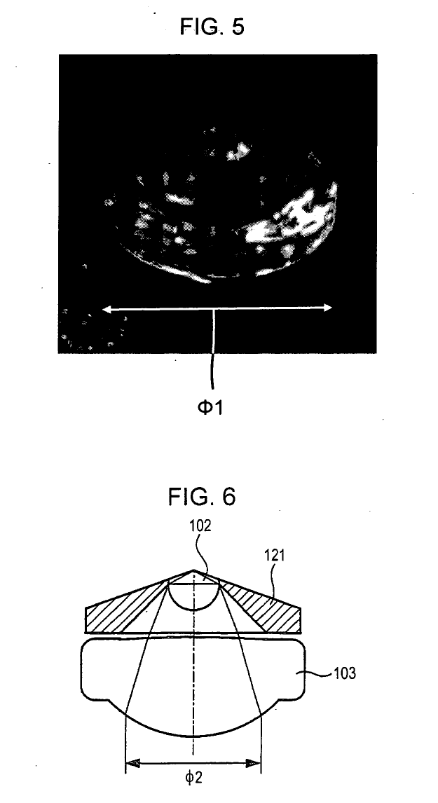

First, as shown in FIG. 4, the hemispherical SIL 2 made of the KTO was produced and was combined and held with an optical lens 3 by a support part 21 made of Al so as to form a condenser lens. The aperture φ1 of the optical lens 3 is 2.4 mm and the diameter Φ1 of the optical lens 3 is 3.3 mm as shown in the picture of FIG. 5.

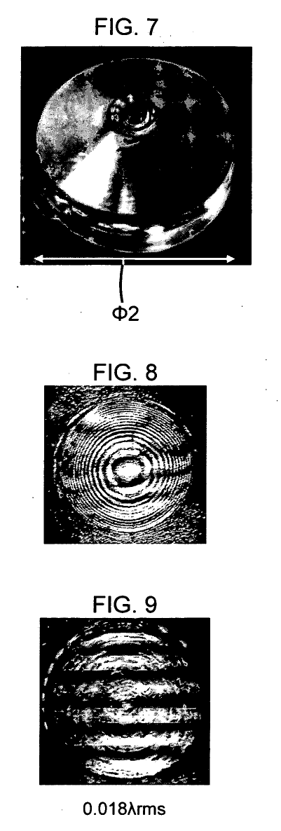

Also, the super hemispherical SIL 102 was produced using the S-LAH79™ made from OHARA INC., which is high .refractive index glass, and was combined and held with an optical lens 103 in the same way using a support part 121 made of Al so as to form a condenser lens. The aperture T2 of the optical lens 103 is 2.4 mm and the diameter Φ2 of the optical lens 103 is 3.9 mm as shown in the picture of FIG. 7. In Table 1 below, materials of the hemispherical SIL and the super hemispherical SIL, diameters of the SILS (hemispherical parts), the numerical apertures of the optical lenses, diameters and weights of lenses, and the effective numerical apertures NA are shown.

TABLE 1

| | hemispherical SIL | | super hemispherical SIL | |
|---|---|---|---|---|
| material | KTaO₃ | | S-LAH79* | |
| SIL hemispherical part | 0.9 | mm | 0.9 | mm |
| diameter | | | | |
| optical lens numerical | 0.77 | | 0.42 | |
| aperture | | | | |
| lens diameter | 3.3 | mm | 3.9 | mm |
| weight | 40 | mg | 65 | mg |
| numerical aperture NA | 1.84 | | 1.84 | |

*made from OHARA INC., TRADE MARK

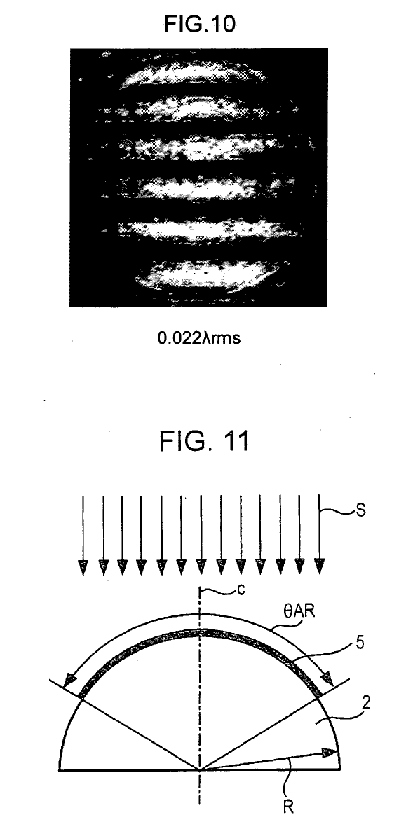

As shown in Table 1 above, the effective numerical aperture NA of the hemispherical SIL and the super hemispherical SIL is 1.84. The interference fringes produced on the surface of the hemispherical part by light with a wavelength of 405 nm incident thereon were observed. The observed pictures are shown in FIGS. 8 to 10. FIG. 8 shows a case where the hemispherical SIL shown in Table 1 has no anti-reflection coating. FIG. 9 shows a case where the hemispherical SIL shown in Table 1 has an anti-reflection coating 5. The anti-reflection coating 5 made of a SiO₂ monolayer is formed within an incident range of the incidence light L1, as shown in the schematic sectional view of FIG. 11. The anti-reflection coating 5 has a thickness along the optical axis of 90 nm and is formed within a range ±60° about the optical axis by sputtering. FIG. 10 shows a case of the super hemispherical SIL shown in Table 1.

As shown in FIG. 8, when the anti-reflection coating is not provided, it is understood that orbicular interference fringes are produced on the entrance surface of the SIL. These interference fringes are characteristic of the hemispherical SIL and are produced by the interfering of incident light with light reflected from the end face of the SIL. When recording on or reproducing from the optical recording medium using the SIL, it is necessary to suppress the interference fringes.

Whereas, as shown in FIG. 9, when the anti-reflection coating is formed on the incident region of incident light, the orbicular interference fringes are scarcely produced in the same way as in the super hemispherical SIL shown in FIG. 10. It is understood that the interference fringes produced by the interfering of incident light with light reflected from the end face of the SIL are suppressed.

In the case where the anti-reflection coating is formed on the hemispherical SIL as shown in FIG. 9, the wavefront aberration is 0.018 λrms. In the case of the super hemispherical SIL shown in FIG. 10, the wavefront aberration is 0.022 λrms.

Then, when such an anti-reflection coating is formed on the SIL, changes in optical characteristics corresponding to the unevenness of the coating thickness are discussed.

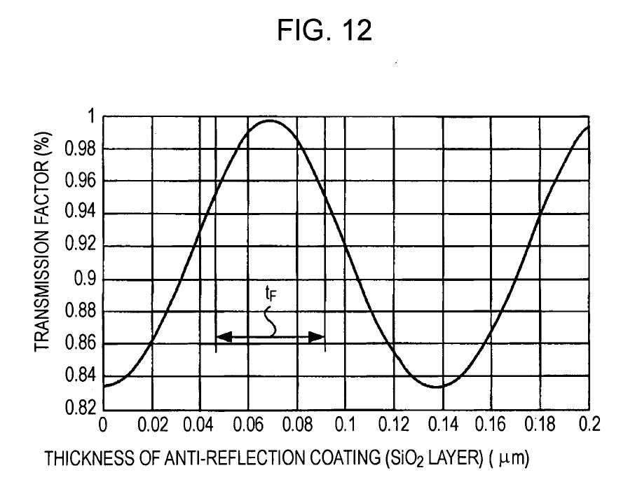

As shown in FIG. 11, when the anti-reflection coating 5 is formed on the hemispherical SIL by sputtering in the arrow direction S, the coating thickness varies with separating distance from the optical axis c, so that it is assumed that optical characteristics change. The situations are shown in FIG. 12. FIG. 12 shows changes in transmission factor against changes in coating thickness when the anti-reflection coating is made of a SiO₂ monolayer. This case is analyzed when it is assumed that the coating thickness in the optical axial direction c is 90 nm. The region from the optical axis to the position displaced from the optical axis by 60° is shown by the arrow range “tf” of FIG. 12, and the coating thickness decreases in the region. However, in this coating thickness range, the transmission factor increases in comparison with the case of the coating thickness 90 nm. Therefore, also in forming such an anti-reflection coating by sputtering, it is understood that a sufficient transmission factor is obtained in recording on or reproducing from the optical recording medium. In particular, when providing the anti-reflection coating made of SiO₂, it is understood that satisfactory transmission factor characteristics are obtained so as to securely avoid or suppress the effect on recording/reproducing characteristics.

Next, an optical pickup device and an optical recoding/reproducing apparatus were configured for recoding/reproducing by irradiating near-field light on the optical recording medium using the hemispherical SIL so as to evaluate recording/reproducing characteristics.

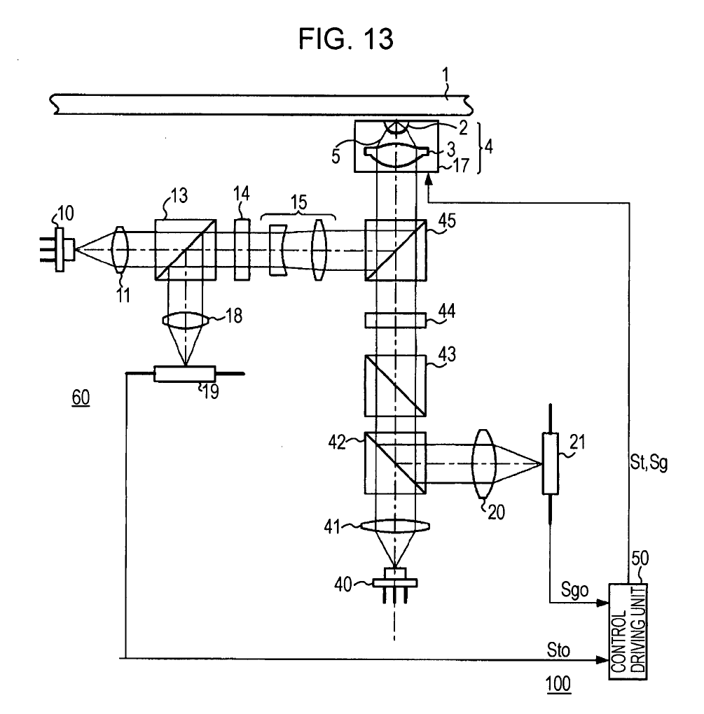

FIG. 13 shows a schematic configuration of an optical recording/reproducing apparatus 100 having an optical pickup device 60 according to a working example of the present invention. The optical pickup device 60 includes a light source 10, and a collimator lens 11, a polarization beam splitter 13, a quarter undulation plate 14, a beam expander 15, and a diachronic prism 45, which are arranged along the light path of the light emitted from the light source 10. The light path is deflected by 90°, for example, with the diachronic prism 45, and the optical lens 3 and a condenser lens 4 composed of the hemispherical SIL 2 are arranged along the deflected light path and held by an actuator 17 composed of a twin- or triple-axis actuator. Along the light path reflected by the polarization beam splitter 13, a light receiving unit 19 is arranged with a lens 18 therebetween.

In such a configuration, the light emitted from the light source 10 is collimated by the collimator lens 11 to pass through the polarization beam splitter 13. Then, the light is regulated in beam width by the beam expander 15 via the quarter undulation plate 14. The light is then reflected by the diachronic prism 45 to enter the condenser lens 4 mounted on the actuator 17, i.e., the optical lens 3 and the hemispherical SIL 2, so as to be irradiated on an optical recording medium 1 as near-field light. The hemispherical SIL 2 is provided with the anti-reflection coating 5 formed on the incident region of incident light.

The light reflected by the recording surface of the optical recording medium 1 is reflected by the diachronic prism 45 via the optical lens 3. Part of the light is reflected by the polarization beam splitter 13 via the beam expander 15 and the quarter undulation plate 14 so as to be focused on a light receiving unit 19 by the lens 18 as a recording/reproducing signal or a tracking detection signal.

In this working example, there is provided light, having a wavelength different from that of recording/reproducing light, for detecting a gap, that is, a distance between the SIL 2 and the surface of the optical recording medium 1. Namely, in this example, a light source 40 with a wavelength different from that of the light source 10 is provided, and along the light path of light emitted from the light source 40, a collimator lens 41, a beam splitter 42, a polarization beam splitter 43, a quarter undulation plate 44, a diachronic prism 45, and further the condenser lens 4 composed of the optical lens 3 and the SIL 2 are arranged. Also, along the light path of light reflected from the beam splitter 42, a light receiving unit 21 is arranged with a lens 20 therebetween.

In such a configuration, the light emitted from the light source 40 is collimated by the collimator lens 41 so as to enter the diachronic prism 45 via the beam splitter 42, the polarization beam splitter 43, and the quarter undulation plate 44. In the diachronic prism 45, the light is combined with the light from the light source 10 so as to be irradiated together with the recording/reproducing light via the optical lens 3 and the SIL 2 as gap detection light.

The gap detection light returned from the optical recording medium 1 passes through the diachronic prism 45 and the quarter undulation plate 44 so as to be mostly reflected by the polarization beam splitter 43. The light leaked from the polarization beam splitter 43 is reflected by the beam splitter 42 so as to be detected by the light receiving unit 21 via the lens 20. Thereby, a small space between the end face of the SIL 2 and the optical recording medium 1, i.e., a gap, can be detected.

In the working example, the gap is detected using changes in polarization. That is, when the gap between the optical recording medium and the SIL is large so that light is substantially totally reflected by the end face of the SIL opposing the optical recording medium, the polarization varies on the end face of the SIL, so that part of light from the polarization beam splitter 43 is leaked in the returning light path. On the other hand, when the optical recording medium is close to the SIL so that the near-field light is leaked and substantially ordinarily reflected, the change in polarization is small so that the light amount leaked from the polarization beam splitter 43 becomes small. The difference, i.e., the changes in total reflection returning light amount, is used so as to be able to detect the gap.

In the recording/reproducing apparatus 100 shown in FIG. 13, on the basis of this change in polarization, a gap detection signal Sg₀ detected in the light receiving unit 21 is entered in a control driving unit 50. To the control driving unit 50, a tracking signal St₀ detected from the light receiving unit 19 is also entered. In the control driving unit 50, based on these signals, a tracking control signal St and a gap control signal Sg are produced so as to control the position of the SIL in a focusing direction (gap direction) opposing the optical recording medium 1 and a tracking direction by being inputted into the actuator 17 holding the SIL and the optical lens 3.

In addition, gap detection also includes various methods such as a method detecting the change in electrostatic capacity.

The optical pickup device and the optical recording/reproducing apparatus according to the embodiment of the present invention are not limited to the working example shown in FIG. 13, so that various modifications can be obviously made in arrangement and configuration of each optical component. The target optical recording medium and its recording/reproducing method include a dedicated system only for reproducing and a recording/reproducing system for both the recording and reproducing. When the optical recording medium records and/or reproduces information by a magneto-optical recording system, a reproducing system with a near-field light may be combined with the magneto-optical recording system so as to incorporate a magnetic coil into part of the optical pickup device.

The embodiment of the hemispherical SIL as listed in Table 1 and having the anti-reflection SiO₂ coating and a comparative example of the super hemispherical SIL were discussed about their optical characteristics using the optical pickup device 60 configured as described above.

In the example below, for reproducing, a dedicated optical recording medium only for reproducing was used in that the material is Si; the track pitch is 226 nm; the pit depth is 60 nm; and the capacity is 50 GB. The recording pits of this optical recording medium were formed by electron beam exposure.

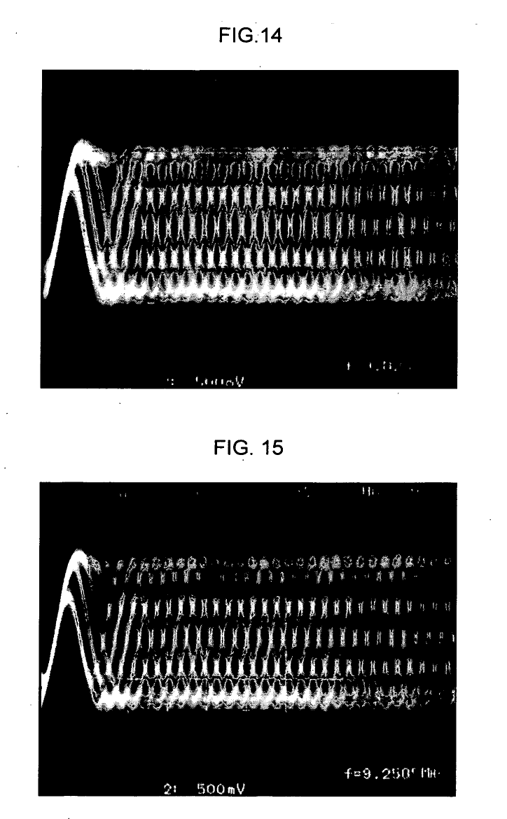

FIGS. 14 and 15 show reproduced waveforms produced on this optical recording medium of the example and the comparative example described above, respectively. The jitter is 3.95% in the example and 3.83% in the comparative example. It is confirmed to have a stable waveform even in the example in the same way as in the comparative example. Other signal characteristics i.e., the modulation degree, the resolving degree, and the asymmetry, are shown in Table 2 below. From Table 2, it is understood that in the optical pickup device and the optical recording/reproducing apparatus including the SIL according to the embodiment of the present invention, stable signal reproducing characteristics are obtained.

TABLE 2

| | | jitter | modu- | | |
|---|---|---|---|---|---|
| | material | % | lation | resolution | asymmetry |
| hemispherical | KTaO3₃ | 3.95 | 0.39 | 0.59 | 0.02 |
| SIL | | | | | |
| super | S-LAH79* | 3.83 | 0.46 | 0.56 | 0.04 |
| hemispherical | | | | | |
| SIL | | | | | |

*made from OHARA INC., TRADE MARK

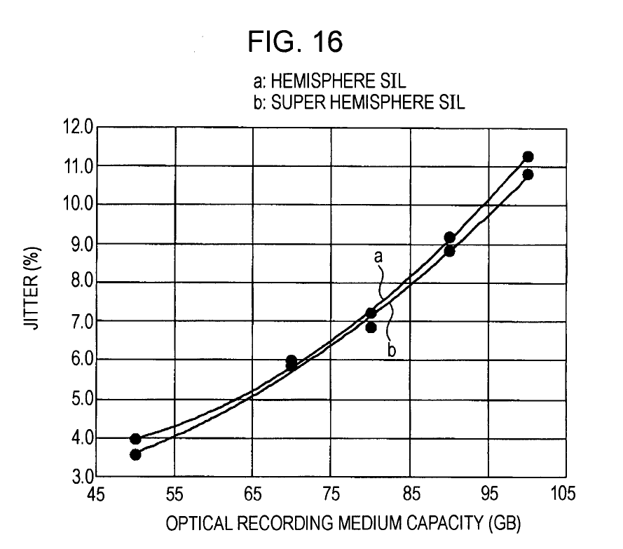

Furthermore, the optical recording media with capacities 70 GB to 100 GB were produced by a phase conversion mastering method for reproducing information with the optical recording/reproducing apparatus in the working example and the comparative example described above, and the jitter was measured. The results are shown in FIG. 16. For the measuring, the optical recording media were used in that the material is polycarbonate; the track pitch is 160 nm; and the pit depth is 60 nm. In FIG. 16, solid line “a” designates the example that uses the hemispherical SIL according to the embodiment of the present invention, and solid line “b” designates the comparative example that uses the super hemispherical SIL.

From FIG. 16, it is understood that the use of the SIL according to the embodiment of the present invention suppresses the jitter in the large-capacity optical recording media with 50 GB to 100 GB to the same extent as in the super hemispherical SIL with the same numerical aperture so as to have favorable signal reproducing characteristics.

As described above, in the SIL according to the embodiment of the present invention, the fabrication is comparatively simple, and the optical characteristics can be favorably maintained without deterioration. The used of the SIL improves the yield of the SIL and the productivity of the condenser lens, the optical pickup device, and the optical recording/reproducing apparatus.

The difference in characteristics between the hemispherical SIL and the super hemispherical SIL is shown in Table 3 below.

TABLE 3

| | hemispherical SIL | super hemispherical SIL |
|---|---|---|
| high numerical aperture | difficult → enabled | Easy |
| | by the invention | |
| tolerable distance | comparatively small | comparatively large |
| between second group | | |
| lenses | | |
| tolerable thickness of | easy | extremely difficult |
| SIL | | |
| chromatic aberration | none | generated |
| generation | | |
| interference fringes | suppressed by anti- | None |
| generation | reflection coating | |

As shown in Table 3 above, in the hemispherical SIL, the use of a high-refraction index material, such as KTO, enables the approach for the higher numerical aperture which has been difficult, in comparison with the super hemispherical SIL. This is the same when a high-refraction index material, such as diamond, is used other than KTO.

The tolerable distance between the SIL and the optical lens combined therewith as the condenser lens is slightly small in the hemispherical SIL rather than in the super hemispherical SIL; however it is within an adjustable range.

On the other hand, the thickness error range of the SIL itself is very narrow in the super hemispherical SIL as mentioned above, and moreover, the range cannot be inconveniently confirmed to be allowable until the combining process with the optical lens. Whereas, in the hemispherical SIL, the thickness error range is large as mentioned above, so that the rate of impossible use in the combining process with the optical lens after being once fabricated is extremely small, improving the yield substantially.

The chromatic aberration is not generated in the hemispherical SIL but generated in the super hemispherical SIL, so that it is necessary in the super hemispherical SIL to use an optical element for correcting the chromatic aberration. Hence, in regard to the chromatic aberration, optical characteristics of the hemispherical SIL are rather favorable so as to be advantageous for miniaturization of the device and simplification of the configuration.

On the other hand, in regard to the interference fringes between reflected light from the end face of the SIL and incident light thereon, in the hemispherical SIL, by providing the anti-reflection coating according to the embodiment of the present invention, the interference fringes can be suppressed or avoided. As apparent from FIGS. 9, 10, and 14 to 16, it is understood that the deterioration in optical characteristics and recording/reproducing characteristics can be sufficiently suppressed.

The SIL, the condenser lens, the optical pickup device, and the optical recording/reproducing apparatus according to the embodiment of the present invention are not limited to the materials and configurations described in the above working example, so that various modifications may be obviously made within the scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A solid immersion lens comprising:
a spherical part being hemispherical on the side opposite to an object; and
an anti-reflection coating provided at least in an incidence range of incident light on the hemispherical spherical part.

2. The solid immersion lens according to claim 1, wherein the solid immersion lens includes KTaO₃.

3. The solid immersion lens according to claim 1, wherein the anti-reflection coating includes SiO₂.

4. The lens according to claim 1, wherein the anti-reflection coating is formed on the spherical part by sputtering.

5. The solid immersion lens according to claim 1, wherein the anti-reflection coating has a thickness of 90 nm in an optical axial direction.

6. The solid immersion lens according to claim 1, wherein the anti-reflection coating is formed in a range of ±60° about an optical axis.

7. A condenser lens comprising:
a solid immersion lens; and
an optical lens arranged opposite to an object and aligned with the solid immersion lens along an optical axis,
wherein the solid immersion lens includes
a spherical part being hemispherical on the side opposite to the object; and
an anti-reflection coating provided at least in an incidence range of incident light on the hemispherical spherical part.

8. The condenser lens according to claim 7, wherein the solid immersion lens includes KTaO₃.

9. The condenser lens according to claim 7, wherein the anti-reflection coating provided on the solid immersion lens includes SiO₂.

10. An optical pickup device, comprising:
a solid immersion lens;
an optical lens arranged opposite to an object and aligned with the solid immersion lens along an optical axis; and
a light source,
wherein light emitted from the light source is focused by a condenser lens composed of the solid immersion lens and the optical lens to form an optical spot, and
wherein the solid immersion lens includes
a spherical part being hemispherical on the side opposite to an object; and
an anti-reflection coating provided at least in an incidence range of incident light on the hemispherical spherical part.

11. The device according to claim 10, wherein the solid immersion lens includes KTaO₃.

12. The device according to claim 10, wherein the anti-reflection coating provided on the solid immersion lens includes SiO₂.

13. The device according to claim 10, further comprising:
a collimator lens configured to collimate light emitted from the light source; and
a beam expander configured to adjust the beam diameter of the collimated light,
wherein light emitted from the beam expander is led to the condenser lens.

14. An optical recording/reproducing apparatus, comprising:
a solid immersion lens;
an optical lens arranged opposite to an object and aligned with the solid immersion lens along an optical axis;
a light source;
an optical pickup device configured to focus light emitted from the light source with a condenser lens composed of the solid immersion lens and the optical lens to form an optical spot; and
control driving means for driving the condenser lens in a focusing direction and/or a tracking direction of an optical recording medium,
wherein the solid immersion lens includes
a spherical part being hemispherical on the side opposite to the object; and
an anti-reflection coating provided at least in an incidence range of incident light on the hemispherical spherical part.

15. The apparatus according to claim 14, wherein the solid immersion lens includes KTaO₃.

16. The apparatus according to claim 14, wherein the anti-reflection coating provided on the solid immersion lens includes SiO₂.

17. An optical recording/reproducing apparatus, comprising:
a solid immersion lens;
an optical lens arranged opposite to an object and aligned with the solid immersion lens along an optical axis;
a light source;
an optical pickup device configured to focus light emitted from the light source with a condenser lens composed of the solid immersion lens and the optical lens to form an optical spot; and
a control driving unit configured to drive the condenser lens in a focusing direction and/or a tracking direction of an optical recording medium,
wherein the solid immersion lens includes
a spherical part being hemispherical on the side opposite to the object; and
an anti-reflection coating provided at least in an incidence range of incident light on the hemispherical spherical part.
